(19) United States
(12) Patent Application Publication
(10) Pub. No.: US 2010/0238042 A1
(43) Pub. Date: Sep. 23, 2010

(54) DENTAL FIXTURE WITH ANTI-LOST SYSTEM

(76) Inventor: Gary Paul, Paramus, NJ (US)

Correspondence Address: AMSTER, ROTHSTEIN & EBENSTEIN LLP, 90 PARK AVENUE, NEW YORK, NY, 10016, US

(21) Appl. No.: 12/724,929

(22) Filed: Mar. 16, 2010

Related U.S. Application Data
(60) Provisional application No. 61/161,428, filed on Mar. 19, 2009.

(51) Int. Cl. G08B 21/18

(52) U.S. Cl. 340/686.6

(57) ABSTRACT

An RFID anti-loss system for a dental fixture is disclosed that can comprise an RFID reader that can transmit radio waves to a passive RFID tag attached to a dental fixture. The passive RFID tag can transmit radio waves in response to the radio waves received by the RFID reader. The RFID reader can intermittently transmit the radio waves such that when a response from the RFID tag is not received by the RFID reader the RFID reader provides an alert.

### CROSS-REFERENCE TO RELATED APPLICATIONS

This application claims priority to U.S. Provisional Patent Application No. 61/161,428, filed Mar. 19, 2009, the content of which is incorporated herein by reference in its entirety.

### FIELD OF THE INVENTION

The present invention generally relates to systems and methods for reducing the chances of losing a dental fixture using a passive RFID tag and RFID reader.

### SUMMARY OF THE INVENTION

In exemplary embodiments, an RFID anti-loss system for a dental fixture can comprise an RFID reader that can transmit radio waves to a passive RFID tag attached to a dental fixture. The passive RFID tag can transmit radio waves in response to the radio waves received by the RFID reader. The RFID reader can intermittently transmit the radio waves such that when a response from the RFID tag is not received by the RFID reader and/or the distance between the RFID tag and the RFID reader is beyond a predetermined distance the RFID reader provides an alert.

The RFID dental fixture can be a retainer. The RFID reader can be located within at least one of a key fob, a bracelet, and a watch.

The RFID tag can be attached to a dental fixture by a resin or acrylic layer bonding the dental fixture to the RFID tag. The RFID tag can be substantially embedded in the dental fixture.

The RFID reader can intermittently transmit to the RFID on a substantially constant basis.

The RFID reader can further comprise a light, a vibrating alert, and/or a speaker. The alert provided by the RFID reader can be a visible alert caused by illuminating the light, a vibrating alert caused by actuating a vibrator, and/or an audible alert caused by a sound generated from the speaker.

The intermittent transmissions from the RFID reader can be designed to transmit a predetermined distance and that distance can be about 10 feet.

In exemplary embodiments, a method for using an RFID anti-loss system for a dental fixture can comprise a transmitting step, wherein intermittent requests are transmitted from an RFID reader to a passive RFID tag affixed to a dental fixture, and a receiving step, wherein a response to the intermittent requests is received at the RFID reader from the passive RFID tag. the method can further comprise, an alert generating step, wherein an alert can be generated when (i) the response is not received at the RFID reader from the passive RFID tag, and/or (ii) the response is received at the RFID reader from the passive RFID tag, and, for example, based on the response from the passive RFID tag, the distance between the RFID reader and passive RFID tag is calculated and determined to be beyond a predetermined distance.

The predetermined distance can be about 10 feet. The RFID reader can be capable of receiving a response from a passive RFID tag about 10 feet from it.

The intermittent transmissions from the RFID reader can be designed to transmit a predetermined distance. The intermittent transmissions can be substantially constant and/or substantially regular.

The dental fixture can be a retainer and/or the RFID reader can be located within a key fob, a bracelet, and/or a watch.

The passive RFID tag can be attached to a dental fixture by a resin or acrylic layer bonding the dental fixture to the passive RFID tag. The passive RFID tag attached to a dental fixture can be substantially embedded in the dental fixture.

The generated alert can be a, a vibration alert caused by actuating a vibrator, visible alert caused by illuminating a light and/or an audible alert caused by a sound generated from a speaker.

### BRIEF DESCRIPTION OF THE DRAWINGS

The features and advantages of the present invention will be more fully understood with reference to the following, detailed description of exemplary embodiments of the present invention when taken in conjunction with the accompanying figures, wherein:

FIG. 1 illustratively depicts a dental fixture including an RFID tag and a device housing an RFID reader, in accordance with embodiments of the invention;

FIGS. 2A-2E illustratively depict an RFID reader alerting a child to retrieve his retainer, in accordance with embodiments of the invention;

FIG. 3 illustratively depicts components of an RFID tag and RFID reader, in accordance with embodiments of the invention; and

FIGS. 4A-4B illustratively depict a protocol for determining when an alert should be generated, in accordance with embodiments of the invention.

### DETAILED DESCRIPTION OF EXEMPLARY EMBODIMENTS

The present invention relates to a system and method for locating removable dental fixtures when such fixtures are removed from the proximity of the user.

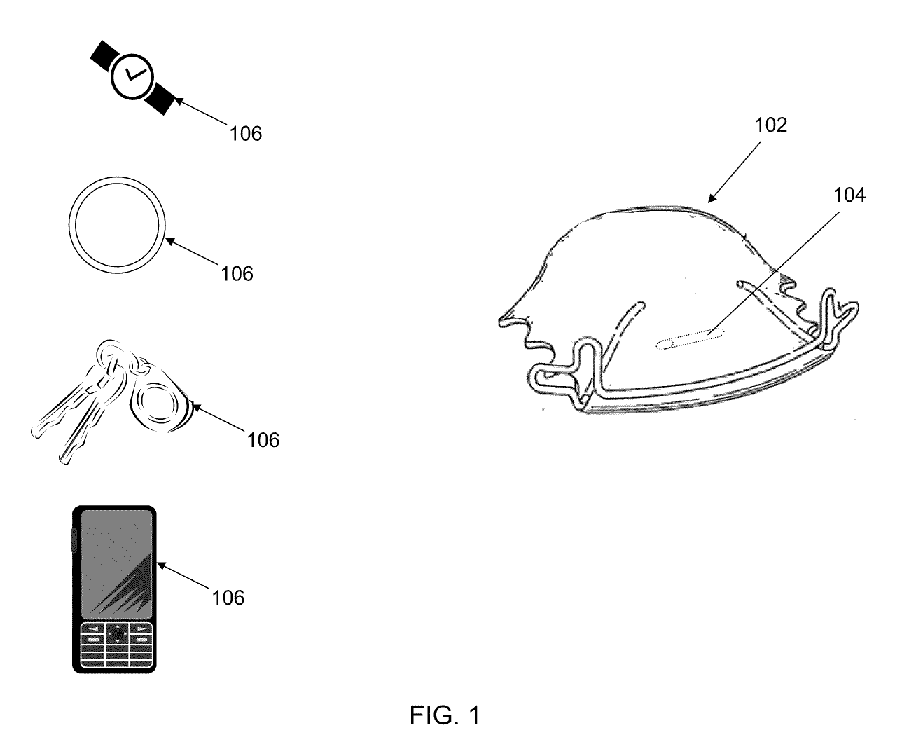

Referring to FIG. 1, in accordance with exemplary embodiments of the present invention, a dental fixture 102, such as a retainer, dentures, or the like, can include an anti-loss device 104 that responds to signals from a reader 106 such that when the dental fixture is separated from the reader beyond a predefined distance the reader and/or the dental fixture can produce an alert. This alert indicates that the dental fixture is not in the vicinity of the reader. By affixing the reader to an object that an individual keeps with them or on them such as a watch, bracelet, key FOB, mobile phone, necklace, an accessory item, to name a few, then the individual would be alerted to the fact that they do not have their dental fixture before it is lost. Thus, the individual would not completely lose the dental fixture and/or the individual would not need to worry as much about finding a lost dental fixture because they would be alerted before they actually lose it. Accordingly, the dental fixture would not get lost and, for example, would not need to be replaced and/or be exposed to additional germs and bacteria.

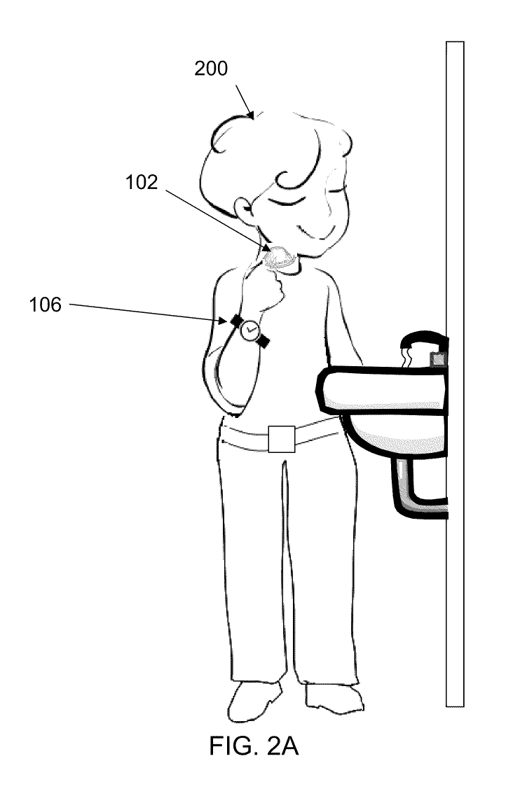

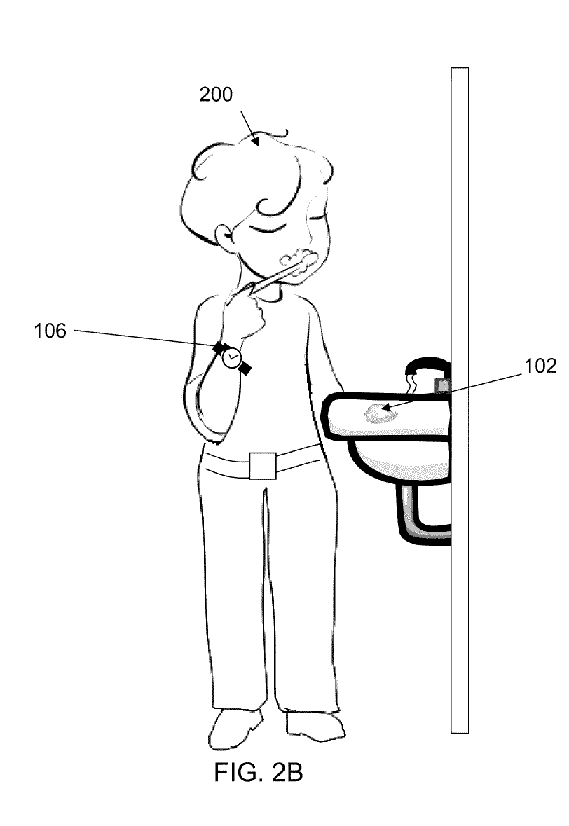

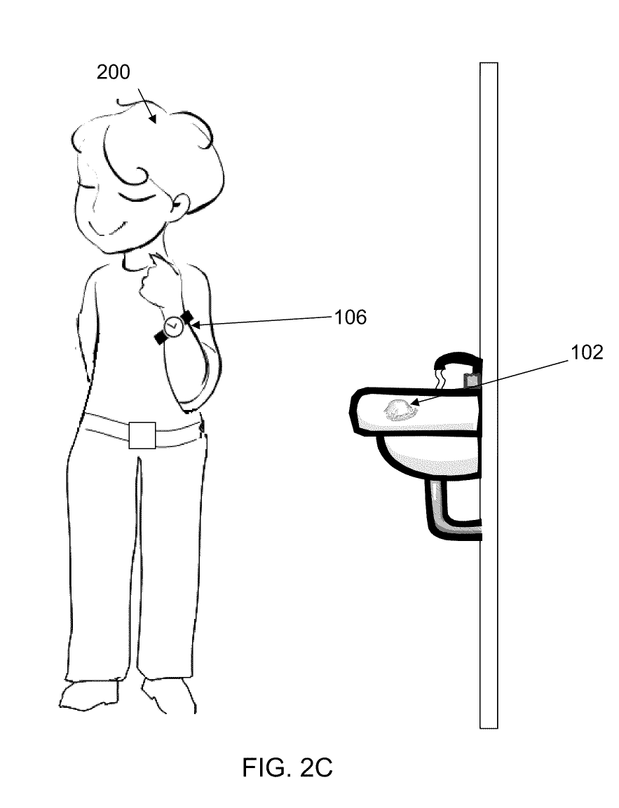

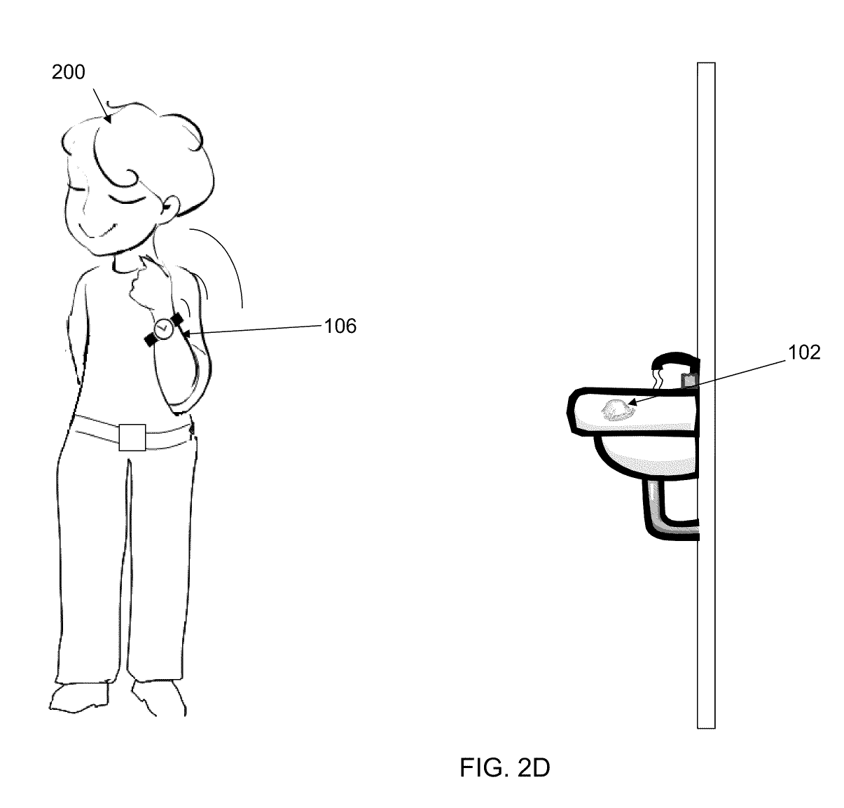

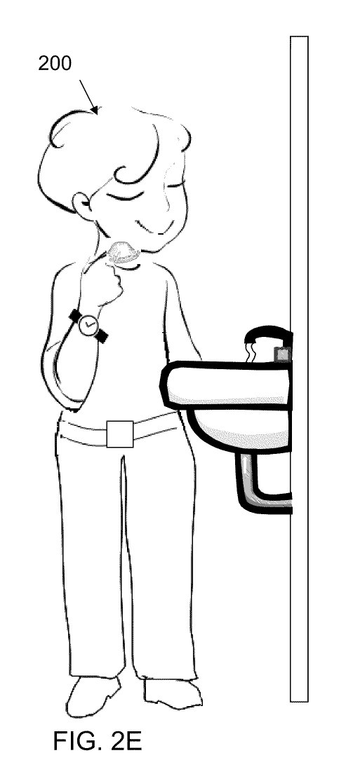

FIGS. 2A-2E illustratively depict the anti-loss system being used by a child wearing a watch affiliated with an RFID reader when the child has removed his retainer having an anti-loss device affiliated with it such that the child does not forget his retainer and consequently does not lose his retainer, in accordance with exemplary embodiments. For example, in FIG. 2A, a boy 200 takes his retainer 102 having an RFID tag imbedded in it out of his mouth so he can brush his teeth, as shown in FIG. 2B. As shown in FIG. 2C, when finished brushing his teeth the boy proceeds to walk away from retainer 102 having an RFID tag imbedded in it. When the boy reaches a predetermined distance RFID reader 106 produces an alert, as shown in FIG. 2D, reminding the boy to retrieve his retainer 102 before it is lost, as shown in FIG. 2E. Accordingly, retainer 102 can be retrieved by the boy before the retainer can be lost.

The anti-loss device can be any reasonable device, such as, but not limited to, a passive RFID tag, an active RFID tag, a battery assisted passive RFID tag; a Bluetooth™ receiver/transmitter, or any other device capable of being affixed and/or imbedded in a dental fixture that can exchange data wirelessly. For ease, the anti-loss device is described herein as a passive RFID tag embedded in a dental fixture, this is in no way meant to be a limitation.

The device for transmitting and/or receiving information from the anti-loss device can be, but is not limited to, a short range RFID transmitter/receiver, a long range RFID transmitter/receiver, a Bluetooth™ receiver/transmitter, or any reasonable device capable of transmitting and/or receiving signals from an anti-loss device. For ease, the device for transmitting and/or receiving information from the anti-loss device is described herein as an RFID reader, this is in no way meant to be a limitation.

The RFID reader can be affiliated with any suitable object, such as, but not limited to, a key fob, bracelet, necklace, watch, mobile phone, a security token, an accessory, or any other reasonable device capable of housing a transmitter. For example, the RFID reader can be an accessory which can releasably couple to a user's clothing by, for example, attaching to a zipper, a belt, and/or a belt loop, to name a few. The accessory item which can releasably couple to a user's clothing can be a stand alone RFID reader and/or can be combined with another device and/or object (e.g., combined with a USB flash drive). Further, the accessory item can be designed to be visually appealing and/or tactilely appealing to a user. For example, the accessory affiliated with an RFID reader can be a substantially soft animal shape which can attach to a child's belt loop or zipper. For example, the accessory can be substantially small such that it can be attached to a swimsuit, shorts, etc. without substantially interfering with a user. For ease, the RFID reader is described herein as being located in a watch, bracelet, key fob, and/or mobile phone, this is not meant to be a limitation. The RFID reader can be affiliated with the object by being located in it, attached to it, in communication with it, or can be affiliated with the object by any reasonable technique. Further, although the RFID reader is described as being separate from the object, it will be understood that at least some and/or all components of the RFID reader can be merged with the object. For example, the RFID reader can be powered by the battery of the object.

The dental fixture can be, but is not limited to, a retainer, dentures, removable partial dentures, removable complete dentures, or any other dental fixture. For ease the dental fixture is described herein as a retainer, this is in no way meant as a limitation. For example, the present invention can be used with other forms of removable dental fixtures such as dentures and the like. Further, it will be understood that the RFID tag can be attached or imbedded in the dental fixture by any reasonable technique. For example, the RFID tag can be imbedded in the acrylic portion of a retainer.

The predefined distance can be based any reasonable distance separating the RFID reader from the RFID tag. The distance can be set, for example, using a computer interface allowing the RFID tag and/or RFID reader to be programmed to a predefined distance. The predefined distance is described as the physical distance between the RFID tag and the RFID reader, however, this distance can be expressed in time. For example, the time it takes to travel a distance or the time it takes to receive a communication between the RFID tag and the RFID reader.

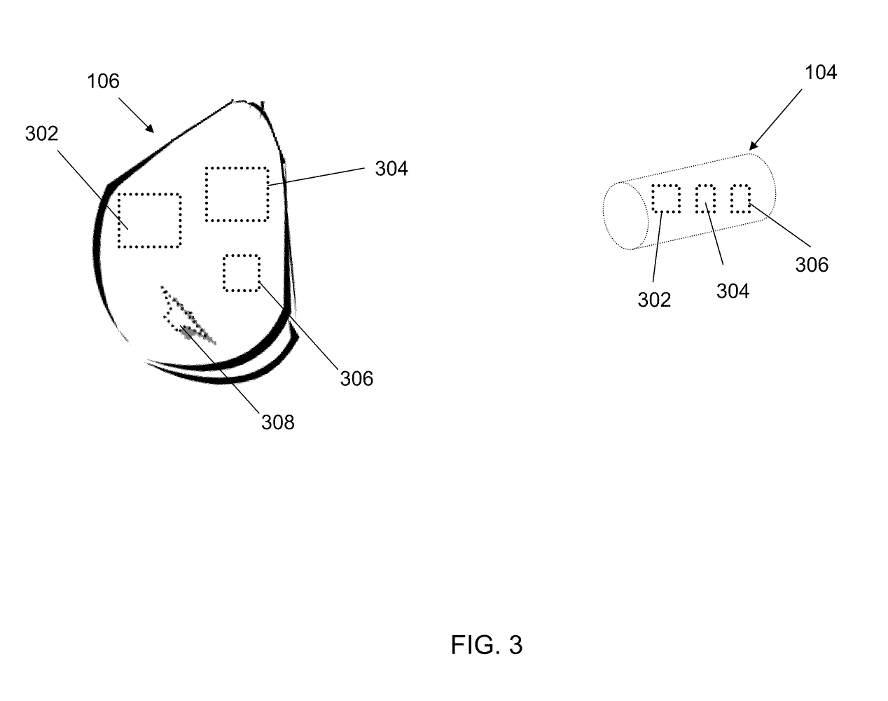

Referring to FIG. 3, in exemplary embodiments, each RFID reader 106 and/or RFID tag 104 can include, but are not limited to, at least one of one or more communications port 302, one or more processor readable memory 304, one or more processor 306, and any other reasonable components for communicating and/or analyzing data. In some instances, RFID reader 106 can include an alert 308 and/or RFID tag 104 can include an alert (not shown). The alert can be a vibrator, speaker, light source, screen, or any other acceptable alert. For example, a vibrator can produce a vibrating alert by actuating the vibrator (e.g., causing an eccentric weight attached to the shaft of a small electric motor to rotate). RFID reader 106 can also a user input (not shown).

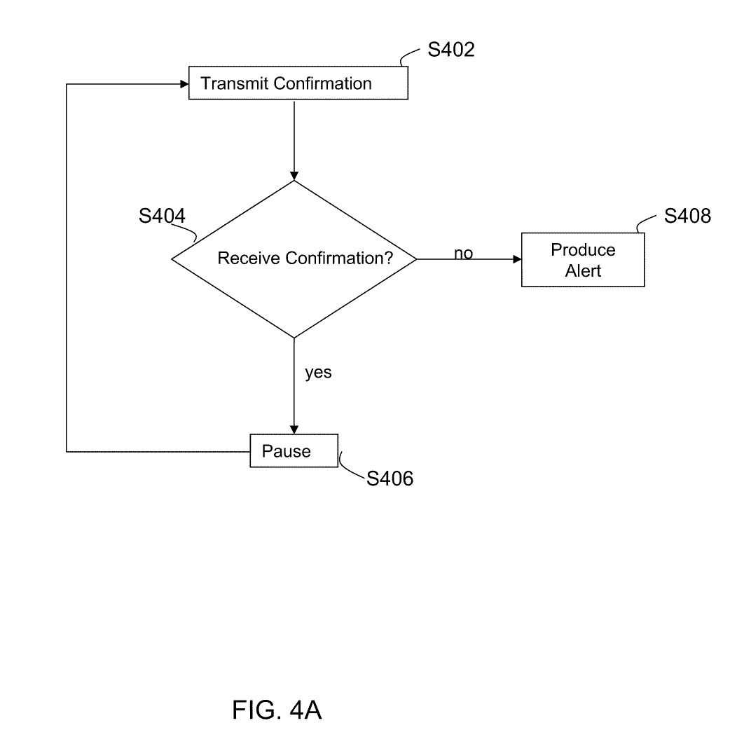

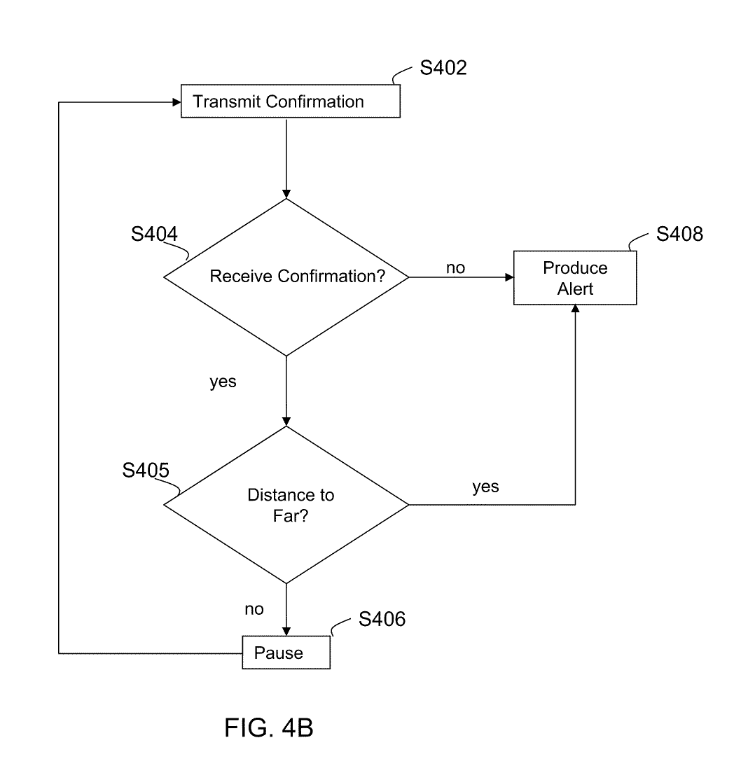

Referring to FIG. 4A, in exemplary embodiments, RFID reader 106 can periodically transmit to RFID tag 104 requesting to receive confirmation from RFID tag 104 and if confirmation is not received back from RFID tag 104 an alert can be generated. For example, at step 402 the RFID reader 106 can transmit a request for confirmation from RFID tag 104. At decision step 404, if a confirmation is received from the RFID tag, the RFID reader can pause, at step 406, a predetermined amount of time before retransmitting another confirmation request. RFID reader 106 and RFID tag 104 can transmit/receive the request/confirmation, for example, via communication port 302. If no confirmation is received from RFID tag 104, RFID reader 106 can generate an alert, at step 408 indicating that confirmation was not received. For example, an alert can be an audible sound played over speaker 308, actuating a vibrating alert (not shown), and/or a flashing light (not shown).

In exemplary embodiments, the duration of time spent at pause step 406 can be programmed by a user and/or automatically programmed to ensure the retainer will not go missing. For example, the pause step can be measured on the scale of seconds, such that, if an alert goes off a user is no more than a few seconds from where the retainer is located. In exemplary embodiments, the duration of time can be substantially short such that a user is less likely to travel far from their retainer. Further, the duration of time can be based on the distance the RFID reader can transmit/receive. For example, the RFID reader may only be capable of receiving transmissions from the RFID tag when they are separated by no more than 10 feet away. In this instance, if the RFID tag can only receive transmission that are no more than 10 feet away and the duration of time for pause step 406 is only a few seconds than a user would only be a few seconds further than 10 feet from their retainer.

Referring to FIG. 4B, in exemplary embodiments, the RFID reader can produce an alert if a confirmation is not received and/or if the confirmation is received but the distance is calculated to be beyond the predetermined set distance. For example, at step 404 if a confirmation is not received then an alert can be produced. As another example, at step 404 if a confirmation is received then, at step 405, the distance from the RFID reader to the RFID tag can be calculated. If the distance calculated is not beyond a predetermined limit then the RFID reader can pause a predetermined time, at step 406. If the distance is calculated to be beyond a predetermined limit then the RFID can generate an alert, at step 408. It will be understood that any reasonable method can be used to calculate the distance. For example, the distance can be can be calculated based on the total time from when a confirmation is transmitted to when confirmation is received. This total time can be compared to a set predetermined amount of time such that if the total time is greater than the set predetermined amount of time an alert can be generated.

It will be understood that any of the steps can be combined, further divided, or be used in conjunction with any other reasonable step without deviating from the scope of the invention.

Now that exemplary embodiments of the present invention have been shown and described in detail, various modifications and improvements thereon will become readily apparent to those skilled in the art. For example, while some examples of uses of the itemized system are discussed other uses are reasonable foreseeable. Accordingly, the spirit and scope of the present invention is to be construed broadly and limited only by the appended claims, and not by the foregoing specification.

What is claimed is:

1. An RFID anti-loss system for a dental fixture, comprising:
an RFID reader that transmits radio waves to a passive RFID tag attached to a dental fixture;
the passive RFID tag transmitting radio waves in response to the radio waves received by the RFID reader;
the RFID reader intermittently transmitting the radio waves such that when a response from the RFID tag is not received by the RFID reader, the RFID reader provides an alert.

2. The RFID dental fixture location system of claim 1, wherein the dental fixture is a retainer.

3. The RFID dental fixture location system of claim 1, wherein the RFID reader is located within at least one of a key fob, a bracelet, and a watch.

4. The RFID dental fixture location system of claim 1, wherein the RFID tag is attached to a dental fixture by a resin or acrylic layer bonding the dental fixture to the RFID tag.

5. The RFID dental fixture location system of claim 1, wherein the RFID tag attached to a dental fixture is substantially embedded in the dental fixture.

6. The RFID dental fixture location system of claim 1, wherein the RFID reader intermittently transmits to the RFID on a substantially constant basis.

7. The RFID dental fixture location system of claim 1, wherein the RFID reader is further comprising,
at least one of a vibrator, light, and a speaker; and
the alert provided by the RFID reader is at least one of vibration alert caused by actuating the vibrator, a visible alert caused by illuminating the light and an audible alert caused by a sound generated from the speaker.

8. The RFID dental fixture location system of claim 1, wherein the intermittent transmissions from the RFID reader are designed to transmit a predetermined distance.

9. The RFID dental fixture location system of claim 8, wherein the predetermined distance is about 10 feet.

10. The RFID dental fixture location system of claim 1, wherein the intermittent transmissions are substantially regular.

11. A method for using an RFID anti-loss system for a dental fixture, comprising:
a transmitting step, wherein intermittent requests are transmitted from an RFID reader to a passive RFID tag affixed to a dental fixture;
a receiving step, wherein a response to the intermittent requests is received at the RFID reader from the passive RFID tag; and
an alert generating step, wherein an alert is generated when at least one of (i) the response is not received at the RFID reader from the passive RFID tag, and (ii) the response is received at the RFID reader from the passive RFID tag, and based on the response from the passive RFID tag, the distance between the RFID reader and passive RFID tag is calculated and determined to be beyond a predetermined distance.

12. The method of claim 11, wherein the predetermined distance is about 10 feet.

13. The method of claim 11, wherein the RFID reader is capable of receiving a response from a passive RFID tag about 10 feet from it.

14. The method of claim 11, wherein the intermittent transmissions from the RFID reader are designed to transmit a predetermined distance.

15. The method of claim 11, wherein the intermittent transmissions are substantially constant.

16. The method of claim 11, wherein the intermittent transmissions are substantially regular.

17. The method of claim 11, wherein the dental fixture is a retainer.

18. The method of claim 11, wherein the RFID reader is located within at least one of a key fob, a bracelet, and a watch.

19. The method of claim 11, wherein the passive RFID tag is attached to a dental fixture by a resin or acrylic layer bonding the dental fixture to the passive RFID tag.

20. The method of claim 11, wherein the passive RFID tag attached to a dental fixture is substantially embedded in the dental fixture.

21. The method of claim 11, wherein the generated alert is at least one of a vibration alert caused by actuating a vibrator, a visible alert caused by illuminating a light, and an audible alert caused by a sound generated from a speaker.
